(19) United States
(12) Patent Application Publication
(10) Pub. No.: US 2012/0121199 A1
(43) Pub. Date: May 17, 2012

(54) IMAGE PROCESSING DEVICE, IMAGE PROCESSING CHIP AND METHOD FOR PROCESSING RAW HIGH RESOLUTION IMAGE DATA

(76) Inventor: Pai-Chu HSIEH, Jhubei City (TW)

(21) Appl. No.: 13/175,005

(22) Filed: Jul. 1, 2011

(30) Foreign Application Priority Data
Nov. 12, 2010 (TW) 099139080

(51) Int. Cl. G06K 9/36

(52) U.S. Cl. 382/244; 382/232

(57) ABSTRACT

A method for processing a raw high resolution image data comprising the following steps: obtaining the raw high resolution image data, compressing the raw high resolution image data and storing the compressed raw high resolution image data in a current image section of a memory, obtaining a reference image data from a reference image section of the memory, decompressing the raw high resolution image data and comparing the reference image data with the decompressed high resolution image data to generate a resulted image data, compressing the resulted image data and storing the compressed resulted image data in the reference image section of the memory.

### BACKGROUND OF THE INVENTION

1. Field of the Invention

This invention relates to an image processing device, an image processing chip thereof, and a method of processing raw image data; specifically to an image processing device for processing raw high resolution image data, an image processing chip thereof, and a method of processing raw high resolution image data.

2. Description of the Prior Art

In the past, the data volume of the low resolution images processed by the dynamic video compression system is approximately only a few kilobytes. The low resolution images do not require a lot of memory space or memory bandwidth, and therefore each low resolution image is directly stored in the memory. However, as resolution increased, the memory space and memory bandwidth required for storing images also increased.

Currently, there are many video compression standards for processing high resolution image data, wherein H.264 is one of the most popular video compression standards on the market. FIG. 1 is a block diagram of a conventional image data processing system 10 using H.264 to compress image data. As FIG. 1 shows, the conventional image data processing system 10 includes an image sensor 20, a memory 30, and a H.264 encoder 40, wherein the memory 30 further includes a current image section 31 and a reference image section 32. Furthermore, the H.264 encoder 40 includes a comparison module 41, a space transformation module 42, a quantization module 43, and a coding module 44, wherein each of the above-mentioned modules is responsible for one different stage within the image data processing.

During video compression, the image sensor 20 of the conventional image data processing system 10 generates a raw high resolution image data H based on images observed. The raw high resolution image data H is then stored in the current image section 31 of the memory 30. Furthermore, a reference image data R is stored in the reference image section 32 of the memory. The comparison module 41 of the H.264 encoder 40 obtains the raw high resolution image data H and the reference image data from the memory 30 The comparison module 41 then compares two image data in order to obtain the difference between two image data.

The H.264 encoder 40 controls the space transformation module 42 and the quantization module 43 based on the above-mentioned difference in order to generate a quantization data. The coding module 44 then uses an entropy coding method or other compression methods to process the quantization data and to generate a data sequence O for a back-end processor to process. Furthermore, the H.264 encoder 40 also controls the space transformation module 42, the quantization module 43, and other image processing modules to reconstruct the quantization data in a format that is suitable for memory storage, wherein the reconstructed quantization data will be extracted as a reference image data from the memory 30 to be compared with the next raw high resolution image data.

However, each of the raw high resolution image data H and the reference image data R processed by the conventional image data processing system 10 requires a considerable amount of memory space (a few megabytes) as well as memory bandwidth. Thus, the conventional image data processing system 10 will require a lot of memory space during dynamic video compression to store the raw high resolution image data H and the reference image data R during dynamic video compression. The requirement for more memory space and more memory bandwidth increases the hardware cost of the conventional image data processing system 10 and decreases the overall efficiency of the video compression. This problem mentioned above shows that processing raw high resolution image data without increasing the memory space use in the image data processing system is one of the important issues in dynamic video compression.

### SUMMARY OF THE INVENTION

It is an objective of the present invention to provide an image processing raw high resolution, an image processing chip thereof, and a method for processing raw high resolution image data in order to save memory space and memory bandwidth.

The image processing chip of the present invention includes a data compression module, a memory, and a coding module, wherein the image processing chip receives a raw image data from an image sensor. The data compression module includes a first compression module and a second compression module, wherein the first compression module compresses the raw image data and then stores the compressed raw image data in a current image section of the memory. Furthermore, a reference image section of the memory includes a reference image data, wherein the reference image data is a processed and coded raw image data stored in the reference image section.

The coding module controls a first compression module and second compression module of the data compression module to decompress the raw image data and the reference image data, wherein the coding module generates a resulted image data based on the difference between the raw image data and the reference image data.

The data compression module can selectively use a lossy or lossless compression method to compress the raw image data and the reference image data. When the data compression module uses a lossy compression method to compress the raw image data, the coding module can use an intra refresh method or other methods to process the raw image data in order to compensate for the loss of image data due to the use of lossy compression method. Furthermore, the first compression module and the second compression module of the present embodiment can choose one of many compression rates to compress the raw image data and the reference image data.

### BRIEF DESCRIPTION OF THE DRAWINGS

FIG. 1 is a block diagram of a conventional image data processing system;

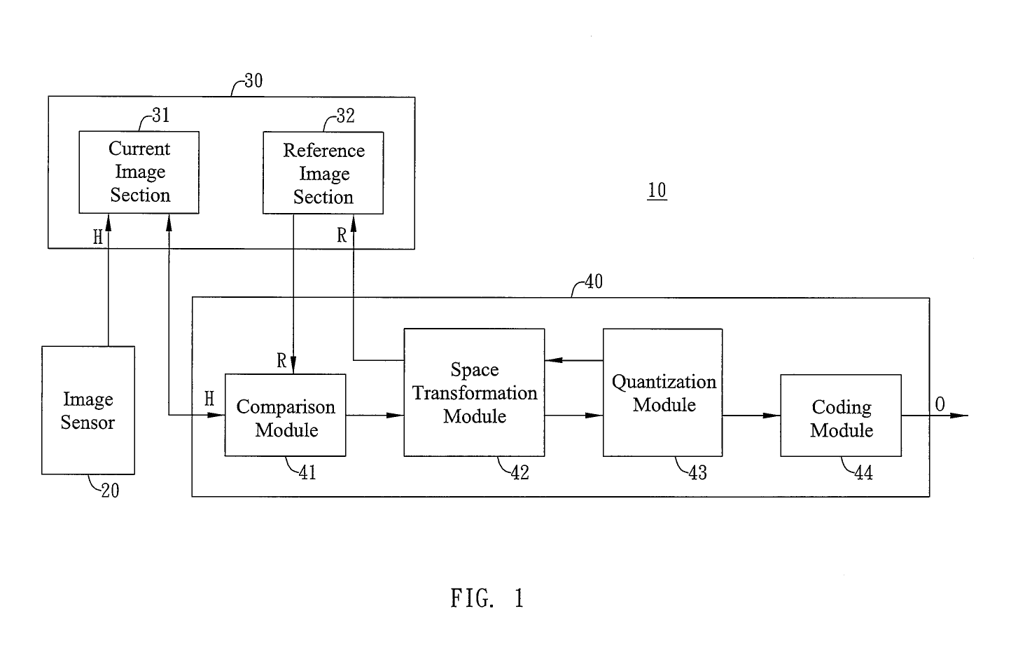

FIG. 2 is a flow chart illustrating the method of processing raw image data of the present invention;

FIG. 3 illustrates a variation of the method of processing raw high resolution image data illustrated in FIG. 2; and

FIG. 4 is a block diagram of the image processing device of the present invention for processing raw high resolution image data.

### DETAILED DESCRIPTION OF THE PREFERRED EMBODIMENT

The present invention relates to an image processing device, an image processing chip thereof, and a method of processing raw image data; specifically to an image processing device for processing raw high resolution image data, an image processing chip thereof, and a method of processing raw high resolution image data.

The image processing device, the image processing chip thereof, and the method of processing raw high resolution image data are preferably used in network imaging modules. The network imaging modules are preferably electronic devices using image sensors or other sensors to obtain static images, dynamic images, or video clips. The network imaging modules then convert those images into digital data to be transmitted via network. The network imaging module can exist independently or can be disposed in electronic devices such as mobile phones, personal computers, and electronic readers. In more preferred embodiments, the network imaging module can be used in digital cameras or cameras in laptop computers, but are not limited thereto. In different embodiments, the image processing chips and the method of processing raw image data thereof can be used in monitors, hand-carried cameras, or other electronic devices that convert images into digital data.

Furthermore, the image processing chips and the method of processing raw image data thereof generate digital image data based on the raw high resolution image data provided by the network imaging module, wherein the network imaging module will transmit those digital image data to at least one of many terminals via an open internet. However, in different embodiments, the network imaging module can be used in a relatively closed intranet to transmit digital image data to at least one of many internal terminals. Furthermore, the network imaging module of the present invention can use various types of wired network interfaces and wireless network interfaces for digital image data transmission between terminals or devices at different locations.

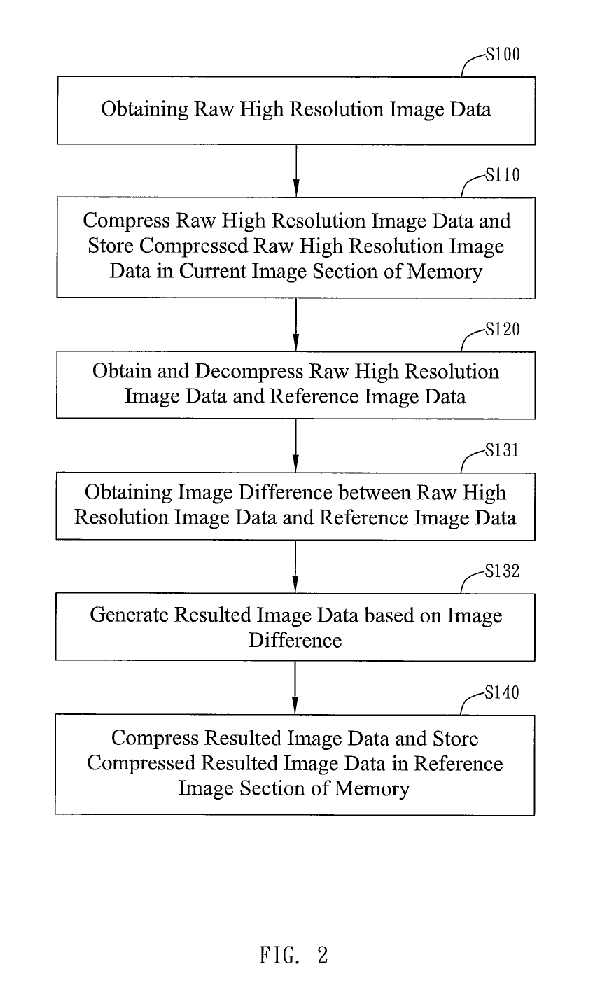

FIG. 2 is a flow chart illustrating the method of processing raw image data of the present invention. As FIG. 2 shows, the method includes step S100 of obtaining raw high resolution image data. Step S100 includes using charge-coupled devices (CCDs) to generate raw high resolution image data, but is not limited thereto; in different embodiments, step S100 can also use complementary metal oxide semiconductors (CMOSs) or other imaging elements to generate raw high resolution image data.

The method of processing raw image data of the present invention includes step S110 of compressing the raw high resolution image data and storing the compressed raw high resolution image data in a current image section of the memory. The image sensor transmits the raw high resolution image data to a data compression module of the image processing chip, wherein the data compression module stores the compressed raw high resolution image data in the current image section of the memory. In the present embodiment, the data compression module uses a lossless compression method, such as the entropy coding method, to process the raw high resolution image data in order to preserve the integrity of the raw high resolution image data. In different embodiments, the data compression module can also use lossy compression methods such as chroma subsampling to process the raw high resolution image data.

As mentioned above, the method of processing raw image data of the present invention compresses the raw high resolution image data before storing it in the memory in order to save memory space. In this way, even if the raw image data generated by the image sensor corresponds to higher resolution, the memory can still be used to store the raw high resolution image data generated by the sensor.

In the present embodiment, step S110 uses a fixed compression rate to compress the raw high resolution image data, but is not limited thereto; in different embodiments, step S110 can select one out of many compression rates to compress the image data based on the size of raw high resolution image data or on other criteria.

Furthermore, the memory of the present embodiment is a dynamic random access memory (DRAM), but is not limited thereto. The memory used in the present invention can be volatile memories such as a static random access memory (SRAM) or non-volatile memories such as an electrically-erasable programmable read-only memory (EEPROM).

The method of processing raw image data further includes step S120 of obtaining the compressed raw high resolution image data from the current image section of the memory and the reference image data from a reference image section of the memory. In the present embodiment, the memory includes the reference image section used to store a plurality of reference image data, wherein the reference image data is the result of previously processed raw high resolution image data. The image processing chip includes a comparison module used to generate a resulted image data based on the above-mentioned raw high resolution image data and the reference image data.

The method of processing raw image data of the present invention includes step S131 of obtaining an image difference between the raw high resolution image data and the reference image data. The method of processing image data of the present invention is used to process a plurality of raw high resolution image data during photography or video capturing, wherein the video clips generated are substantially continuous and therefore only slight differences exist between the raw high resolution image data and the previously calculated reference image data. Thus, the method of processing the raw image data can use the image difference generated in step S131 to reduce the steps required for processing raw image data and therefore save on the calculation resources used.

The method of processing the raw image data further includes step S132 of generating a resulted image data based on the image difference. As mentioned above, step S131 compared the raw high resolution image data decompressed in step S120 with the reference image data to obtain the image difference between two image data. Step S132 includes transforming the image difference mentioned above into a transformation matrix, wherein the transformation matrix of the present embodiment is an 8×8 matrix, but is not limited thereto. In different embodiments, the transformation matrix can also be a 4×4 matrix. The raw high resolution image data includes a plurality of sample data, wherein a space transformation module converts each sample data into data such as luminance, chrominance, and chroma. Furthermore, after the sample data is converted into data mentioned above, a space transformation module of the image processing chip will transform each one of the luminance, the chrominance, and the chroma to a 8×8 transformation matrix, but is not limited thereto. In different embodiments, the transformation matrix also includes 4×4 matrixes, wherein the transformation matrix mentioned above is defined in a space domain.

Step S132 includes quantizing the transformation matrix mentioned above in order to transform the transformation matrix into a quantization matrix. Human eyes are not sensitive to the variation of luminance in images. Thus, a quantization module of the image processing chip is used to reduce the data contained in coefficients of the transformation matrix with greater amplitude according to how the human eyes react to variation in luminance. The quantization module first divides each coefficient of the transformation matrix by a constant and then rounds off each coefficient to the nearest integer. In the present embodiment, the majority of the coefficients with greater amplitude will be adjusted to 0 and therefore the quantization of the present embodiment will reduce the amount of information contained in the transformation matrix and save the memory space.

Step S132 includes performing inverse quantization and inverse transformation in order to transform the quantization matrix to the reference image data, wherein the reference image data and the raw high resolution image data of the present embodiment have the same format.

The method of processing raw image data of the present invention further includes step S140 of compressing the resulted image data and storing the compressed resulted image data in the reference image section of the memory. The coding module first transmits the resulted image data to the data compression module of the image processing chip. The data compression module compresses the resulted image data and stores the compressed resulted image data in the reference image section of the memory so that the image processing chip can compare the reference image data and the raw high resolution image data in step S131. In other words, the newly generated resulted image data will be used as the reference image data used in the next step S131.

As FIG. 2 shows, the method of processing high resolution image data of the present invention includes step S140 of compressing the resulted image data and storing the compressed resulted image data in the reference image section of the memory, wherein the resulted image data stored in the reference image section will be used as the reference image data to be compared with the next raw high resolution image data. Furthermore, step S140 of the present embodiment includes compressing the resulted image data based on a fixed compression rate, but is not limited thereto. In different embodiments, step S140 can also compress the resulted image data based on one of many compression rates.

In the embodiment illustrated in FIG. 2, the method of processing raw high resolution image data compresses the raw image data in step S110 and the resulted image data in step S140. In different embodiments, the method of processing raw high resolution image data can selectively compress only one of the raw image data and the resulted image and then store the compressed image data in the memory.

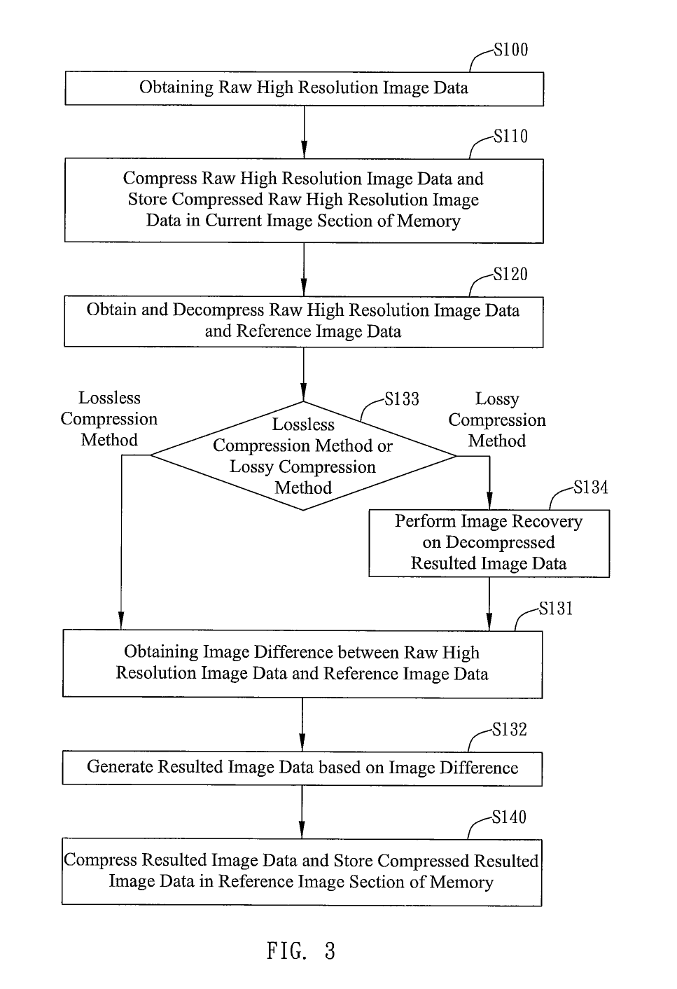

FIG. 3 illustrates another embodiment of the method of processing raw high resolution image data of the present invention. In the present embodiment, step S140 can selectively use a lossless compression method or a lossy compression method to compress the resulted image data. Step S140 preferably uses a lossless compression method in order to preserve the integrity of the resulted image data, but is not limited thereto. Step S140 can also use a lossy compression method to compress the resulted image data in order to reduce the amount of data contained in the resulted image data and save the memory space for data storage.

As FIG. 3 shows, the method of processing high resolution image data of the present invention includes step S133 of determining the method of compressing the resulted image data. When the resulted image data is compressed using a lossless compression method, the compressed resulted image data will be stored in the reference image section of the memory. However, when the resulted image data is compressed using a lossy compression method, the compressed resulted image data will lose a portion of its data and therefore sustain damage.

In order to compensate for the damages generated by using the lossy compression method, the method of processing image data includes step S134 of performing image recovery on the resulted image data selectively based on the method used to compress the resulted image data. The damaged resulted image data generated during previous steps will sustain further damage if compressed by a lossy compression method so that step S131 can calculate the difference between the decompressed raw high resolution image data and the resulted image data. If step S140 of the present embodiment uses a lossy compression method to compress the resulted image data, step S134 will recover the damage in the resulted image data created by the use of lossy compression method in order to prevent step S140 from generating resulted image data with further damages. In this way, step S134 can prevent the damage inflicted on the resulted image data from being transmitted and expanded.

In the present embodiment, step S134 will control the comparison module to use the intra refresh method to repair the damages created by the lossy compression method used to compress the resulted image data. In order to prevent the expansion of damages in the resulted image data, the comparison module will periodically pick one of many reference image data stored in the reference image section of the memory to replace the damaged resulted image data in need of repairs. In different embodiments, the comparison module can use the picture segmentation method or other image repair method to repair the damage inflicted on the resulted image data.

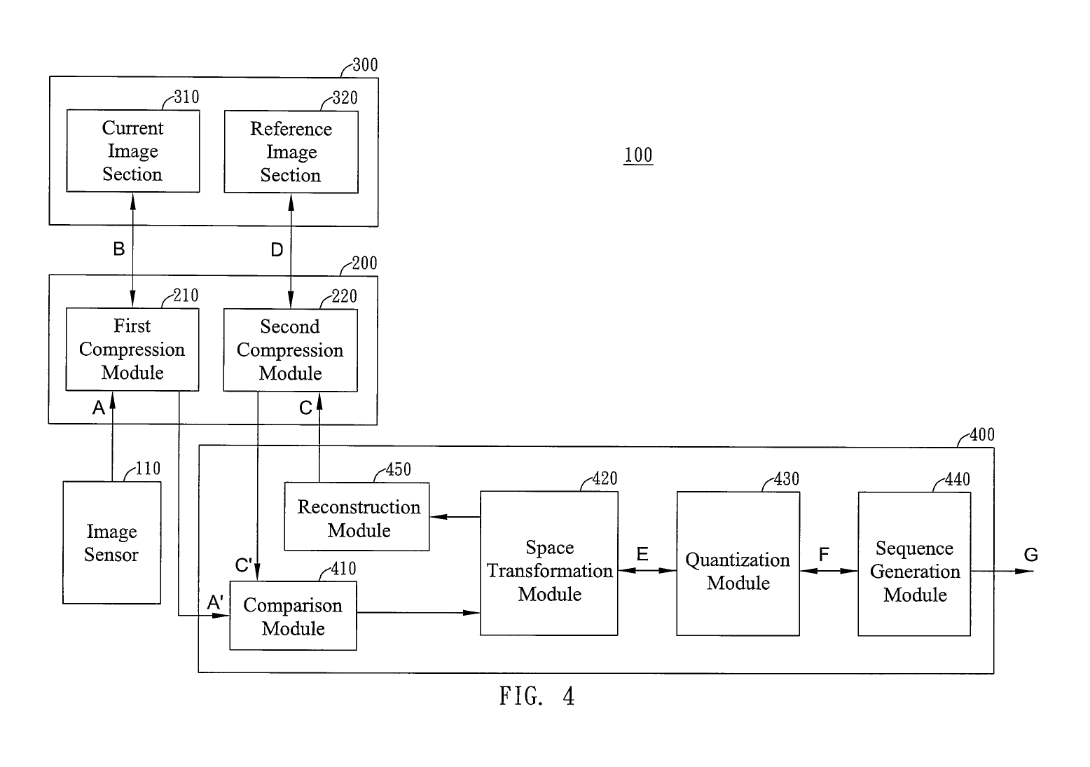

FIG. 4 is a block diagram of the image processing device 100 of the present invention used to process raw high resolution image data. The image processing device 100 includes an image sensor 110, a data compression module 200, a memory 300, and a coding module 400. As FIG. 4 shows, the data compression module 200 includes a first compression module 210 and a second compression module 220. The memory 300 includes a current image section 310 and the reference image section 320. The first compression module 210 is connected to the image sensor 110, the current image section 310, and the coding module 400. The second compression module 220 is connected to the reference image section 320 and the coding module 400. Furthermore, the coding module 400 includes a comparison module 410, a space transformation module 420, a quantization module 430, a sequence generation module 440, and a reconstruction module 450.

In the embodiment illustrated in FIG. 4, the image sensor 110 is a camera or other image sensors for converting images into raw image data A. The image sensor 110 of the present embodiment can generate a raw image data A whose resolution is higher than 1280×720, but is not limited thereto. In different embodiments, the image sensor 110 can selectively generate raw image data A with resolution lower than 1280×720. Furthermore, the raw image data A mentioned above includes raw, yuv or other formats in the video compression field. In addition, the image sensor 110 of the present embodiment includes a charge-coupled device (CCD), but is not limited thereto. In different embodiments, the image sensor 110 also includes complementary metal oxide semiconductor (CMOS) or other imaging components used to generate raw image data A based on the images observed.

The image sensor 110 then transmits the raw image data A to the first compression module 210 where the raw image data A is compressed based on a chosen video compression method chosen. The first data compression module 210 then stores the compressed raw image data A in the current image section 310 of the memory 300. In this way, the compressed raw image data B generated by the first data compression module 210 occupies less memory space. This shows that the first compression module 210 can save memory space for data storage by compressing the raw image data A. Furthermore, the first compression module 210 of the present embodiment uses a lossless compression method such as entropy coding method to process the raw image data A, but is not limited thereto. In different embodiments, the first compression module 210 can also use a lossy compression method, such as quantization, to process the raw image data A.

In the present embodiment, the reference image section 320 stores a compressed resulted image data D. The coding module 400 compares the reference image data C′ and the decompressed raw image data A′, and generates a new resulted image data C based on the difference between the two image data. The coding module 400 only needs to perform coding on the difference between the reference image data C and the raw image data A′ and does not need to process the entire raw image data A. In this way, the coding module 400 can save memory space in the memory 300 by compressing the image data.

Before obtaining the image difference between the reference image data and the raw image data, the comparison module 410 of the coding module 400 needs to first obtain the compressed raw image data A′ from the current image section 310 of the memory 300, wherein the first compression module 210 performs decompression on the compressed image data A′. Furthermore, the second compression module 220 will obtain a compressed resulted image data D from the reference image section 320 of the memory 300 and will then perform video decompression in order to generate the reference image data C′. The comparison module 410 then obtains and compares the decompressed raw image data A′ and the reference image data C′ from two compression modules 210 and 220. However, in different embodiments, the coding module 400 can generate the resulted image data C from only the decompressed raw image data A′.

The space transformation module 420 of the coding module 400 transforms the image difference into a transformation matrix E, wherein the transformation matrix E is an 8×8 matrix. In different embodiments, the transformation matrix E also includes a 4×4 matrix. The image difference includes a plurality of sample data, wherein the space transformation module 420 transforms each sample data into data such as luminance, chrominance, and chroma. Furthermore, after sample data is converted into the data mentioned above, the space transformation module 420 will transform each one of the luminance, the chrominance, and the chroma to an 8×8 or a 4×4 transformation matrix E, wherein the data contained in the transformation matrix E is defined in a space domain.

Furthermore, the space transformation 420 of the coding module 400 is used to transform the transformation matrix E from a space domain to a frequency domain. Each coefficient contained in the transformation matrix E represents the luminance and chrominance of the corresponding image at a certain location in space. The space transformation module 420 transforms each coefficient of the transformation matrix E into a frequency component in the frequency domain. The space transformation module 420 of the present embodiment use the discrete cosine transformation method to perform the transformation mentioned above. In different embodiments, the space transformation module 420 can also use the wavelet transformation, Fourier transformation, or any other methods to transform the signal from the space domain to the frequency domain.

The coding module 400 further includes a quantization module 430 for transforming, based on a quantization table stored in the memory 300, the transformation matrix E outputted by the space transformation module 420 into a quantization matrix F. Human eyes are not sensitive to the variation of luminance in images and the quantization module is used to reduce the data contained in coefficients of the transformation matrix with greater amplitude based on how the human eyes react to variation in luminance. The quantization module first divides each coefficients of the transformation matrix E by a constant and then rounds off each coefficient to the nearest integer. In the present embodiment, the majority of the coefficients with greater amplitude will be adjusted to 0. This shows that the quantization performed in the present embodiment reduces the amount of data contained in the transformation matrix E and thus saves the memory space for data storage.

As FIG. 4 shows, the coding module 400 includes a sequence generation module 440 and a reconstruction module 450, wherein the sequence generation module 440 is used to transform the quantization matrix F into a data coded sequence G. Furthermore, the data coded sequence G and the raw image data A have the same data format and can be stored in the memory 300. In the present embodiment, the quantization matrix F includes a direct current coefficient and other types of coefficients. Therefore, the sequence generation module 440 can be used to generate a coding table using different types of coding methods. The sequence generation module 440 then uses the coding table to transform the quantization matrix F. In the present embodiment, the sequence generation module 440 uses a Hoffman coding method and a run-length coding method to process different coefficients within the quantization matrix F. In different embodiments, the sequence generation module 440 can also use arithmetic coding or entropy coding to process different coefficients in the quantization matrix F in order to generate the data coded sequence G.

In the embodiment illustrated in FIG. 4, the quantization module 430 can perform inverse-quantization on the quantization matrix F to reconstruct a transformation matrix E and return the coefficients with higher frequency components back to the state before quantization. The space transformations module 420 receives and converts the transformation matrix E to a format that can be transmitted to a reconstruction module 450, wherein the reconstruction module 450 then reconstructs the data received in order to generate a resulted image data C.

Furthermore, the second compression module 220 of the present embodiment accepts the resulted image data C from the coding module 400 and selectively uses a lossless compression method or a lossy compression method to compress the resulted image data C and then stores the compressed resulted image data D in the reference image section 320.

In the embodiment illustrated in FIG. 4, the first compression module 210 and the second compression module 220 use a fixed compression rate to compress the raw high resolution image data A and the resulted image data C, but are not limited thereto. In different embodiments, the first compression module 210 and the second compression module 220 can selectively use one of many compression rates. In addition, user can choose to selectively use one of the first compression module 210 and the second compression module 220 to use different compression rates to compress the image data based on criteria, such as the current usage of the memory 300 and the storage capacity of the memory 300.

In addition, in the present embodiment, the first compression module 210 uses a lossless compression method or a lossy compression method to compress the raw high resolution image data A. Similarly, the second compression method 220 can use the Hoffman coding method, the arithmetic coding method, or any other lossless compression method to process the image data. The second compression module 220 can also use a lossy compression method, such as wavelet transformation or frequency coding, to process the resulted image data C. However, the lossy compression method will cause the compressed resulted image data D to lose some data and in this way damage the compressed resulted image data D.

When the second compression module 220 uses a lossy compression method to compress the resulted image data C, the comparison module 410 of the present embodiment will use the intra refresh method to repair the damage in the compressed resulted image data resulting from the use of lossy compression method. In this way, the comparison module 410 can prevent the occurrence and expansion of the damage in the image data. In this way, the comparison module 410 can prevent the damages inflicted on the compressed resulted image data D from being transmitted and expanded through repairs. The comparison module 410 periodically selects a reference image data from the reference image section 320 to replace the reference image data needing repairs in order to prevent the damages from expanding, but is not limited thereto. In different embodiments, the comparison module 410 can also use picture segmentations method or other image restoration techniques to repair the damaged reference image data.

In the embodiment illustrated in FIG. 4, the image processing device 100 of the present invention for processing the raw high resolution image data uses the first compression module 210 to compress the raw high resolution image data A. The image processing device 100 then uses the second compression module 220 to compress the resulted image data C generated by the coding module 400, but is not limited thereto. In different embodiments, in order to save the time required for the compression module 200 to process the image data, the compression module 200 can use only the first compression module 210 to compress the raw high resolution image data A or use only the second compression module 220 to compress the resulted image data C. In other words, in different embodiments, the compression module 200 can compress only one of the raw high resolution image data A and the resulted image data C to save the corresponding compression steps required.

The above is a detailed description of the particular embodiment of the invention which is not intended to limit the invention to the embodiment described. It is recognized that modifications within the scope of the invention will occur to a person skilled in the art. Such modifications and equivalents of the invention are intended for inclusion within the scope of this invention.

What is claimed is:

1. A method of processing a raw high resolution image data generated by a network imaging module, comprising the following steps:
obtaining the raw high resolution image data;
obtaining a reference image data from a memory;
generating a resulted image data based on the raw high resolution image data and the reference image data; and
compressing at least one of the raw high resolution image data and the resulted image data and storing the compressed raw high resolution image data or the compressed resulted image data in the memory.

2. The method of claim 1, wherein the step of compressing the raw high resolution image data includes storing the compressed raw high resolution image data in a current image section of the memory, the step of compressing the resulted image data includes storing the compressed resulted image data in a reference image section of the memory.

3. The method of claim 1, wherein the step of compressing the raw high resolution image data includes compressing the raw high resolution image data based on a lossless compression method, the step of compressing the resulted image data includes compressing the resulted image data based on the lossless compression method.

4. The method of claim 1, wherein the step of compressing the raw high resolution image data includes compressing the raw high resolution image data based on a lossy compression method, the step of compressing the resulted image data includes compressing the resulted image data based on a lossless compression method.

5. The method of claim 3, when the resulted image data is compressed by using the lossless compress method, the method comprising the following steps:
obtaining the reference image data from the memory;
comparing the raw high resolution image data and the reference image data to obtain an image difference;
generating a transformation matrix based on the image difference;
transforming the transformation matrix into a quantization matrix based on a transformation table; and
transforming the quantization matrix into a coded data sequence based on a coding table.

6. The method of claim 4, when the resulted image data is compressed by using the lossless compress method, the method comprising the following steps:
obtaining the reference image data from the memory;
comparing the raw high resolution image data and the reference image data to obtain an image difference;
generating a transformation matrix based on the image difference;
transforming the transformation matrix into a quantization matrix based on a transformation table; and
transforming the quantization matrix into a coded data sequence based on a coding table.

7. The method of claim 1, wherein the step of compressing the raw high resolution image data includes compressing the raw high resolution image data based on a lossy compression method, the step of compressing the resulted image data includes compressing the resulted image data based on the lossy compression method.

8. The method of claim 1, wherein the step of compressing the raw high resolution image data includes compressing the raw high resolution image data based a lossless compression method, the step of compressing the resulted image data includes compressing the resulted image data based on a lossy compression method.

9. The method of claim 7, when the resulted image data is compressed based on the lossy compression method, the method comprising:
image-processing the resulted image data to generate a transformation matrix;
transforming the transformation matrix into a quantization matrix based on a transformation table; and
transforming the quantization matrix into a coded data sequence based on a coding table.

10. The method of claim 8, when the resulted image data is compressed based on the lossy compression method, the method comprising:
image-processing the resulted image data to generate a transformation matrix;
transforming the transformation matrix into a quantization matrix based on a transformation table; and
transforming the quantization matrix into a coded data sequence based on a coding table.

11. The method of claim 1, wherein the step of compressing the raw high resolution image data includes compressing the raw high resolution image data based on a first compression rate, the step of compressing the resulted image data includes compressing the resulted image data based on a second compression rate.

12. An image processing chip used in a network imaging module to process a raw high resolution image data, the image processing chip comprising:
a memory including a reference image data;
a coding module for generating a resulted image data based on the raw high resolution image data and the reference image data; and
a data compression module for compressing at least one of the raw high resolution image data and the resulted image data and storing the compressed raw high resolution image data or the compressed resulted image data in the memory.

13. The image processing chip of claim 12, wherein the data compression module includes a first compression module and a second compression module, the first compression module compresses the raw high resolution image data and stores the compressed raw high resolution image data in the memory, the second compression module compresses the resulted image data and stores the compressed resulted image data in the memory.

14. The image processing chip of claim 12, wherein the memory includes a current image section used to store compressed raw high resolution image data and a reference image section used to store the compressed resulted image data, the coding module generates the resulted image data based on the compressed raw high resolution image data from the current image section and the reference image data from the reference image section.

15. The image processing chip of claim 12, wherein the data compression module compresses the raw high resolution image data based on a lossless compression method, the data compression module compresses the resulted image data based on the lossless compression method.

16. The image processing chip of claim 12, wherein the data compression module compresses the raw high resolution image data based on a lossy compression method, the data compression module compresses the resulted image data based on a lossless compression method.

17. The image processing chip of claim 15, when the data compression module compressing the resulted image data based on the lossless compression method, the coding module will compare the decompressed raw high resolution image data and the reference image data to obtain an image difference and generate a coded data sequence based on the image difference.

18. The image processing chip of claim 16, when the data compression module compressing the resulted image data based on the lossless compression method, the coding module will compare the decompressed raw high resolution image data and the reference image data to obtain an image difference and generate a coded data sequence based on the image difference.

19. The image processing chip of claim 12, wherein the data compression module compresses the raw high resolution image data based on a lossy compression method, the data compression module compresses the resulted image data based on the lossy compression method.

20. The image processing chip of claim 12, wherein the data compression module compresses the raw high resolution image data based on a lossless compression method, the data compression module compresses the resulted image data based on a lossy compression method.

21. The image processing chip of claim 19, when the data compression module compresses the resulted image data based on the lossy compression method, the coding module will perform image processing on the decompressed raw high resolution image data and generate a transformation matrix, the data compression module transforming the transformation matrix into a quantization matrix based on a quantization table and then transforming the quantization matrix into a coded data sequence based on a coding table.

22. The image processing chip of claim 20, when the data compression module compresses the resulted image data based on the lossy compression method, the coding module will perform image processing on the decompressed raw high resolution image data and generate a transformation matrix, the data compression module transforming the transformation matrix into a quantization matrix based on a quantization table and then transforming the quantization matrix into a coded data sequence based on a coding table.

23. The image processing chip of claim 12, wherein the data compression module includes at least a first compression rate and a second compression rate, the data compression module compresses the raw high resolution image data based on the first compression rate and compresses the resulted image data based on the second compression rate.
